(19) United States
(12) Patent Application Publication
(10) Pub. No.: US 2010/0303556 A1
(43) Pub. Date: Dec. 2, 2010

(54) METHOD AND APPARATUS IN A SUCTION CONVEYING SYSTEM OF MATERIAL

(76) Inventor: Göran Sundholm, Tuusula (FI)

Correspondence Address: BIRCH STEWART KOLASCH & BIRCH, PO BOX 747, FALLS CHURCH, VA, 22040-0747, US

(21) Appl. No.: 12/744,759

(22) PCT Filed: Nov. 10, 2008
(86) PCT No.: PCT/FI08/50644

§ 371 Date: May 26, 2010

(30) Foreign Application Priority Data
Nov. 27, 2007 (FI) 20075841

(51) Int. Cl. B65G 53/66

(52) U.S. Cl. 406/12

(57) ABSTRACT

A method in a vacuum conveying system, which vacuum conveying system comprises at least one feed point (61, 66), a material conveying pipe (100, 101, 102) which is connected to the feed point (61, 66) and at the other end to a separator element (20) in which the material being conveyed is separated from conveying air, and means (3) for providing a pressure difference in the conveying pipe (100, 101, 102) at least for the time of conveying the material. In the method, conveying air is monitored with at least one fire detector (500) and, based on the detection, the conveying system is affected by isolating the fire to a certain part of the system and/or by diminishing the conditions of burning. The invention also relates to an apparatus.

### BACKGROUND OF INVENTION

The invention relates to a method in a vacuum conveying system according to the preamble of claim 1, which vacuum conveying system comprises at least one feed point, a material conveying pipe which is connected to the feed point and at the other end to a separator element in which the material being conveyed is separated from conveying air, and means for providing a pressure difference in the conveying pipe at least for the time of conveying the material.

The invention also relates to an apparatus according to claim 8.

The invention generally relates to vacuum conveying systems which are particularly intended for collecting and conveying waste, such as conveying household waste, and particularly to the fire-safety of the systems in question.

Systems are known in which waste is conveyed in a piping by means of suction. In these, waste is conveyed for long distances in the piping by suction. Apparatuses are utilised, inter alia, for conveying waste in different institutions. Typical for them is that a vacuum apparatus is used for achieving a pressure difference, in which apparatus, underpressure in the conveying pipe of material is provided with vacuum generators, such as vacuum pumps or an ejector apparatus. In the conveying pipe, there is typically at least one valve element by opening and closing of which make-up air coming in the conveying pipe is regulated.

A vacuum conveying system, such as a waste conveying system, can be vulnerable to fires if e.g. waste catches fire in a waste bin operating as a feed point. The fire can spread along the conveying piping of the conveying system, when burning or smouldering material, such as waste, is conveyed in the piping of the system to a delivery site, such as a waste bin or further processing.

An object of this invention is to achieve a totally novel arrangement into connection with material conveying systems, by means of which the disadvantages of known arrangements are avoided. Another object of the invention is to provide an arrangement suitable for vacuum conveying systems, by means of which a material conveying system, particularly a waste material conveying system, better of its fire-safety than earlier is provided.

### BRIEF DESCRIPTION OF INVENTION

The invention is based on an idea in which a fire detector is arranged in a suction channel of a material conveying system.

The method according to the invention is mainly characterised in that, in the method, conveying air is monitored with at least one fire detector and, based on the detection, the conveying system is affected by isolating the fire to a certain part of the system and/or by diminishing the conditions of burning.

In addition, the method according to the invention is characterised by what is stated in claims 2-7.

The apparatus according to the invention is characterised in that the apparatus comprises at least one fire detector which is arranged in a conveying piping and/or a feed piping and/or a suction piping.

The apparatus according to the invention is further characterised by what is stated in claims 9-14.

The arrangement according to the invention has numerous significant advantages. By arranging the fire detector in the suction channel of the material conveying system, an early and quick fire detection is provided. By arranging the fire detector in the suction piping, e.g. after a separator element, it is possible to avoid the dirtying problems of the detector and to maintain the fire detector reliably operational. By arranging stopper/regulation elements, particularly valve elements, openable and closable based on fire detection, it is possible to prevent the access of fire in the material and/or to isolate the fire to a certain part of the piping and/or diminish the conditions of burning in the piping. The conditions of burning are diminished, on the one hand, by preventing oxygen from accessing the fire site and, on the other hand, by providing suction by means of which part of oxygen is removed from the space whereby the fire extinguishes. If the fire has already accessed the piping, the provided suction extinguishes the fire. The fire detector is advantageously located in a secondary channel of suction, whereby a quick detection and extinguishing process occurring by means of underpressure i.e. suction is provided. Underpressure is advantageously tried to be provided in the piping, which pressure is so high that oxygen content at the fire site diminishes below 12%, whereby the fire extinguishes. It has been observed that typically this objective is reached by underpressure which is about 0.3-0.5 bar. According to an embodiment of the invention, a water ejector operates best as the generator of underpressure, because flue gases having accessed the conveying piping will cool down when carried from the effect of suction to an ejector pipe of the ejector device where they cool down when passing a water spray of the ejector. Conventional vacuum pumps can instead spread the fire, because flue gases are not, inter alia, cooled down in any way. Pressure water functioning as the actuating medium of the water ejector can also be used as extinguishing water e.g. in the conveying piping or the separator or a material tank, such as a container.

### BRIEF DESCRIPTION OF FIGURES

Next, the invention will be described in detail by means of an example with reference to the accompanying drawings in which

FIG. 1 schematically shows a system in accordance with an embodiment according to the invention in one operating position,

FIG. 2 schematically shows a system in accordance with an embodiment according to the invention in another operating position.

### DETAILED DESCRIPTION OF INVENTION

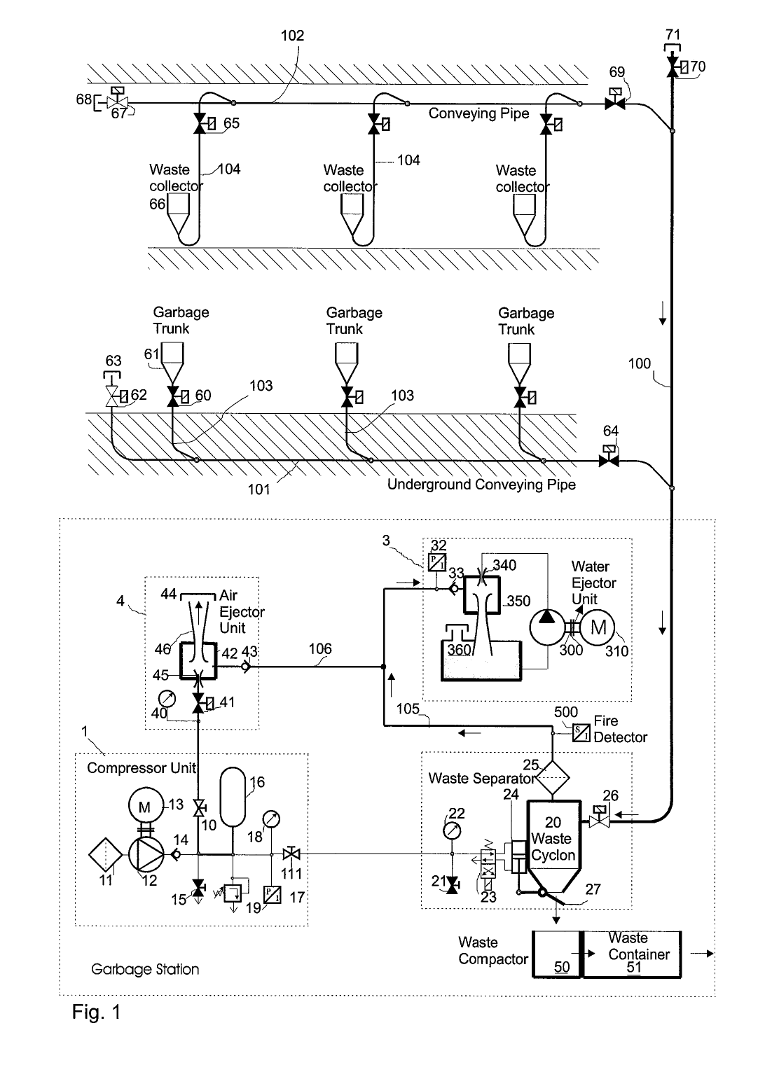

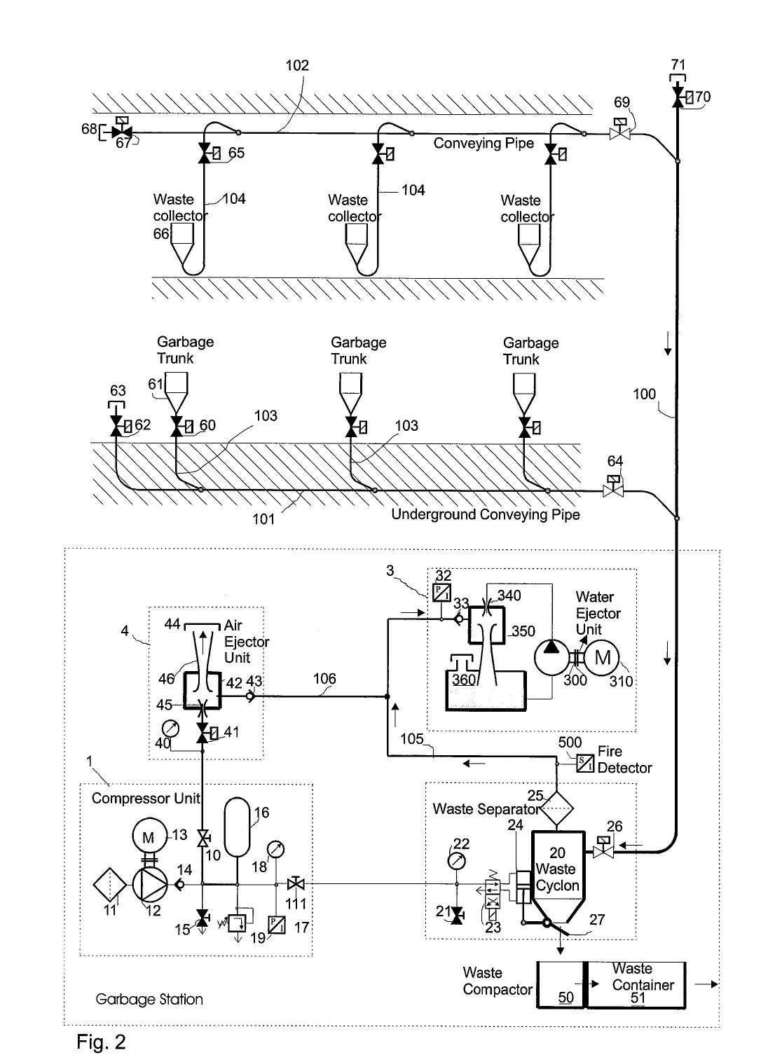

FIGS. 1 and 2 schematically show a material conveying system, particularly a waste material conveying system, utilising the method and the apparatus according to the invention.

In the figures, reference numbers 61, 66 designate a feed station of waste material intended for conveyance, from which station material, particularly waste material, such as household waste, intended for conveyance is fed to the conveying system. The system can comprise several feed stations 61, 66 from which the material intended for conveyance is fed to a conveying piping 100, 101, 102, 103, 104. Typically, the conveying piping comprises a main conveying pipe 100 into which several branch conveying pipes 101, 102 can have been connected and into which, for their part, several feed stations 61, 66 can have been connected via feed pipes 103, 104. In the embodiment according to FIGS. 1 and 2, into the main conveying pipe 100 are connected two branch conveying pipes 101, 102. In the figures, into both branch conveying pipes 101, 102 are connected three feed stations 61 and 66. The fed material is conveyed along the conveying piping 100, 101, 102, 103, 104 to a separator device 20 at the opposite end of the conveying piping, in which device the material being conveyed is separated, e.g. by means of centrifugal force, from conveying air. The separated material is removed, e.g. when required, from the separator device 20 to a material container, such as a waste container 51, or for further treatment. The material container can comprise, as in the embodiment of the figures, a waste compactor 50 from which the material is further conveyed to the waste container 51. In the embodiment of FIGS. 1 and 2, the separator device 20 is provided with material outlet elements 23, 24, 27. From the separator device 20, a pipe 105 leads further to means 3, 4 for generating underpressure in at least one conveying pipe 100.

In the embodiment of the figure, the means for generating underpressure i.e. vacuum generators comprise a first ejector unit 3 and a second ejector unit 4. By the underpressure generating means, underpressure required for conveying the material is provided in the conveying piping 100, 101, 102, 103, 104.

In accordance with the figures, the system can further comprise the second ejector unit 4 which is connected in the embodiment of the figure to the conveying pipe via pipes 106, 105 and the separator element 20.

In the embodiment according to the figures, the ejector pump 3 is used for generating basic underpressure in the conveying piping instead of vacuum pumps. The suction side of the ejector pump 3 is coupled via the pipe 105 to the separator element 20, whereby suction is provided in the conveying pipe 100. The ejector pump 3 employs liquid, typically water, as the actuating medium which is pumped by a pump device 300 from a container 360 to an ejector nozzle 340. This provides suction on the suction side of the ejector pump which is connected to the pipe 105. Liquid, typically water mist, sprayed by the ejector nozzle returns to the container 360 from which it is conveyed to be re-sprayed by the pump. In the embodiment of the figures, the second ejector device 4 is used to provide an intensified vacuum effect (a vacuum shock) in the conveying pipe 100. The second ejector unit 4 comprises an ejector nozzle 45 from which actuating medium is sprayed to an ejector 42 into an ejector pipe 46, whereby it provides suction in the pipe 106. The ejector unit 4 is connected to an actuating-medium source, such as a pneumatic source 1, which typically comprises at least one compressor 12 and pneumatic accumulator 16. Underpressure provides the required force for conveying the material in the conveying piping. The ejector unit 4 is connected to the separator device 20, into which, again, the main conveying pipe 100 is connected. The second ejector unit 4 is not necessary from the viewpoint of the operation of this invention.

To the feed pipe 103, 104 is arranged an outlet valve 60, 65 which is opened and closed so that material portions of suitable size are conveyed from the feed point 61, 66 to the conveying pipe 101, 102. Material is fed from the feed point 61, 66, such as a waste container, when after the container is full, the outlet valve 60, 65 is opened either automatically or manually. To each conveying pipe 100, 101, 102 is arranged, most suitably at the opposite end of the conveying pipe with respect to the separator device 20, a line valve 62, 67, 70 which is opened and closed when required.

In the embodiments of the figures, the separator element 20, which is a so-called waste cyclone, the first ejector unit 3, the second ejector unit 4, and the compressor unit 1 have been located at the delivery end of material of the material conveying system i.e. particularly into connection with a waste station in the waste conveying system. The feed points can be located decentralised along the system pipings distributedly. In connection with the waste conveying system, the feed points can be e.g. waste bins or waste chutes.

According to the invention, the system comprises at least one fire detector 500 which is arranged in the conveying piping 100, 101, 102 and/or the feed piping 103, 104 and/or the suction piping 105, 106. Widely considered, the fire detector 500 can be in any suction channelling which comprises the conveying piping 100, 101, 102 and/or the feed piping 103, 104, the separator element 20, and the suction pipe 105 connecting the separator element 20 to at least one ejector device 3.

In the method according to the invention, conveying air of the vacuum conveying system is monitored with at least one fire detector 500 and, based on the detection, the conveying system is affected by isolating the fire to a certain part of the system and/or by diminishing the conditions of burning.

According to an advantageous embodiment of the invention, in the method, based on the detection in a fire situation, the fire is isolated by closing at least part of valves 60, 62, 64, 65, 67, 70 of the conveying piping 100, 101, 102 and/or the feed piping 103, 104.

According to another embodiment of the invention, in the method, the fire is affected by diminishing the conditions of burning by closing at least one valve 60, 62, 65, 67, 70 affecting the access of inlet air and/or by maintaining underpressure in the piping at least in the fire area.

According to an advantageous embodiment of the invention, an ejector device, which employs liquid as the actuating medium, is used as the vacuum generator 3. The embodiment of the figures also shows a second ejector device by means of which a vacuum pulse is provided in the system. According to an advantageous embodiment, also the second ejector device 4 employs liquid as the actuating medium.

According to an advantageous embodiment of the invention, at least part of combustion gases, such as flue gases, caused by the fire is conveyed to the spray of the ejector device 3.

By means of the invention, the flue gases of the conveying piping can be cooled down in the actuating medium spray of the ejector device 3. Simultaneously, the spreading of the fire can be effectively prevented.

It is also possible to spray the actuating medium of the ejector device 3 in the conveying piping in a fire situation, whereby it is possible to effectively extinguish a fire possibly prevailing in the piping. The spraying can be implemented e.g. by arranging a pipe provided with a valve element from the pump device 300 to the conveying piping, whereby in a fire situation the valve is opened and liquid, such as water, employed as the actuating medium by the ejector device is sprayed in the conveying piping.

The invention also relates to an apparatus in a vacuum conveying system, which vacuum conveying system comprises at least one material feed point 61, 66, a material conveying pipe 100, 101, 102 which is connected to the feed point 61, 66 and at the other end to a separator element 20 in which the material being conveyed is separated from conveying air, and means 3 for providing a pressure difference in the conveying pipe 100, 101, 102 at least for the time of conveying the material. The apparatus comprises at least one fire detector 500 which is arranged in a conveying piping 100, 101, 102 and/or a feed piping 103, 104 and/or a suction piping 105, 106.

According to an embodiment of the invention, at least one fire detector 500 is arranged in the suction piping 105 between the separator element 20 and the vacuum generator 3. Between the separator element and the fire detector in the suction pipe is arranged a filter element 25. By arranging the fire detector 500 in the suction channelling after the separator element 20 and the filter element, the dirtying of the fire detector can be effectively avoided.

The apparatus comprises valve elements 60, 62, 64, 65, 67, 69, 70 in the conveying piping 100, 101, 102 and/or the feed piping 103, 104 and/or the suction piping 105, 106, which are controlled on the basis of signals given by the fire detector 500.

In the conveying system according to the invention, for generating underpressure at least in the conveying piping 100, 101, 102 is used at least one ejector device 3.

According to the invention, the vacuum generator used in generating underpressure is the ejector device 3 which employs liquid as the actuating medium.

In the system according to the invention, at least part of material feed points 61, 66 are waste feed points, such as waste bins or waste chutes, which are connected to the conveying piping.

According to an embodiment of the invention, the fire detector 500 is a smoke detector. The fire detector can be a detector based on some other change characteristic of fire known as such, such as a detector reacting to temperature.

On the basis of a signal received from the fire detector 500, the valves 60, 62, 65, 67, 70 of the material conveying piping are controlled in a desired way. In accordance with an embodiment according to the invention, the fire is tried to be isolated and/or the conditions of fire diminished. According to another advantageous embodiment, the valves of the piping are closed, whereby the access of possibly burning material in the piping is prevented and/or at least the access of oxygen necessary for burning in the piping is prevented and/or the fire is isolated. According to another embodiment, the valves 62, 67 controlling the access of inlet air are kept closed, but at least the line valve 64, 69 of the fire site is opened, whereby underpressure is able to affect the desired part of the conveying piping.

It is obvious to those skilled in the art that the invention is not isolated to the embodiments described above, but it may be varied within the scope of the enclosed claims. When necessary, the features possibly described in this specification together with other features may also be used separately from each other.

1. A method in a vacuum conveying system, which vacuum conveying system comprises at least one feed point, a material conveying pipe which is connected to the feed point and at the other end to a separator element in which the material being conveyed is separated from conveying air, and means for providing a pressure difference in the conveying pipe at least for the time of conveying the material, wherein, in the method, conveying air is monitored with at least one fire detector and, based on the detection, the conveying system is affected by isolating the fire to a certain part of the system and/or by diminishing the conditions of burning.

2. A method according to claim 1, wherein, in the method, based on the detection in a fire situation, the fire is isolated by closing at least part of valves of conveying piping and/or feed piping.

3. A method according to claim 1, wherein, in the method, the fire is affected by diminishing the conditions of burning by closing at least one valve affecting the access of inlet air and/or by maintaining underpressure at least in the fire area.

4. A method according to claim 1, wherein as the vacuum generator is used an ejector device which employs liquid as the actuating medium.

5. A method according to claim 1, wherein also the second ejector device employs liquid as the actuating medium.

6. A method according to claim 1, conveying at least part of combustion gases, such as flue gases, caused by the fire to the spray of the ejector device.

7. A method according to claim 1, characterised by cooling down the flue gases of the conveying piping in the actuating medium spray of the ejector device.

8. An apparatus in a vacuum conveying system, which vacuum conveying system comprises at least one material feed point, a material conveying pipe which is connected to the feed point and at the other end to a separator element in which the material being conveyed is separated from conveying air, and means for providing a pressure difference in the conveying pipe at least for the time of conveying the material, wherein the apparatus comprises at least one fire detector which is arranged in a conveying piping and/or a feed piping and/or a suction piping.

9. An apparatus according to claim 8, wherein at least one fire detector is arranged in the suction piping between the separator element and the vacuum generator.

10. An apparatus according to claim 8, wherein the apparatus comprises in the conveying piping and/or the feed piping and/or the suction piping valve elements which are controlled on the basis of signals given by the fire detector.

11. An apparatus according to claim 8, wherein for generating underpressure in the conveying piping at least one ejector device is used.

12. An apparatus according to claim 8, wherein the vacuum generator is an ejector device which employs liquid as the actuating medium.

13. An apparatus according to claim 8, wherein at least part of the material feed points are waste feed points, such as waste bins or waste chutes, which are connected to the conveying piping.

14. An apparatus according to claim 8, wherein the fire detector is a smoke detector.

15. A method according to claim 2, wherein, in the method, the fire is affected by diminishing the conditions of burning by closing at least one valve affecting the access of inlet air and/or by maintaining underpressure at least in the fire area.

16. A method according to claim 2, wherein as the vacuum generator is used an ejector device which employs liquid as the actuating medium.

17. A method according to claim 3, wherein as the vacuum generator is used an ejector device which employs liquid as the actuating medium.

18. A method according to claim 2, wherein also the second ejector device employs liquid as the actuating medium.

19. A method according to claim 3, wherein also the second ejector device employs liquid as the actuating medium.

20. A method according to claim 4, wherein also the second ejector device employs liquid as the actuating medium.
